(19) United States
(12) Patent Application Publication
(10) Pub. No.: US 2015/0363329 A1
(43) Pub. Date: Dec. 17, 2015

(54) MEMORY ADDRESS TRANSLATION

(71) Applicant: Hamilton Sundstrand Corporation, Charlotte, NC (US)

(72) Inventors: Daniel Precourt, Ellington, CT (US); Marcin Wroblewski, Unionville, CT (US)

(73) Assignee: Hamilton Sundstrand Corporation, Charlotte, NC (US)

(21) Appl. No.: 14/303,147

(22) Filed: Jun. 12, 2014

(51) Int. Cl. G06F 12/10

(52) U.S. Cl. CPC G06F 12/1027; G06F 12/1009; G06F 2212/68; G06F 2212/657

(57) ABSTRACT

In one example, a device includes at least one processor, a transceiver configured to send and receive data, and at least one memory device. The at least one memory device includes a range of physical memory addresses divided into a plurality of physical memory partitions that each includes a sub-range of the range of physical memory addresses and corresponds to a range of virtual memory addresses. Instructions encoded in the at least one memory device cause the at least one processor to receive a memory address request configured to request access to a requested physical memory address within the range of physical memory addresses, determine that the requested physical memory address is associated with one of the plurality of physical memory partitions, determine a virtual memory address corresponding to the requested physical memory address, and access the requested physical memory address via the determined virtual memory address.

### BACKGROUND

The present disclosure relates generally to memory access of computer-readable memory, and in particular to memory access of computer-readable memory having a plurality of physical memory partitions.

Many modern computing devices implement test interfaces that enable read/write operations to memory used by the computing device via software variable names representative of the memory location. For example, modern avionics devices (e.g., flight control computers, air data computers, or other such computing devices) typically implement test interfaces that allow a user (e.g., a system's designer, a tester, a customer, etc.) to read and/or write data to memory locations of the avionics device from a testing device, such as a personal computer. Such test interfaces can facilitate trouble-shooting, fault retrieval, formal testing, or other such activities.

Typically, test interfaces include an embedded component, resident as part of the embedded software programed in the avionics device, and a test application implemented using, e.g., a personal computer (PC). The test application typically transmits read and/or write requests to the avionics device to request the embedded component to read and/or write data to memory of the avionics device. To facilitate ease of use by the tester (e.g., a user), the test application may typically enable access to a memory location of the avionics device using a variable name representative of the memory location. For instance, a tester may request, via a user interface of the test application, a status of a variable name such as “fault_status.” In operation, the test application may typically implement a symbol table that correlates variable names to a corresponding physical memory address (e.g., in random access memory) in the memory of the avionics device. Using the symbol table, the test application can translate the variable name (e.g., “fault_status”) to a corresponding physical memory address and transmit a command to the avionics device requesting access to the physical memory address. In response, the avionics device can transmit a response including the contents of the requested physical memory address (or, in cases when the access request is a write command, write a requested value to the physical memory address).

More recently, certain industries (e.g., the aerospace industry) have begun implementing software and system architectures using real-time operating systems that isolate memory access of applications executing on the system to certain ranges of memory, often referred to as memory partitions. For instance, physical memory of a device may be divided into multiple partitions, each partition having one or more applications assigned to the partition. The real-time operating system limits memory access of each application to the memory within the partition to which it is assigned, thereby helping to prevent memory corruption between applications and partitions. In one such implementation, defined by the Aeronautical Radio, Incorporated (ARINC) Specification 653: Avionics Application Standard Software Interface (often abbreviated ARINC-653) and commercially available from the Rockwell Collins corporation, memory access is controlled via virtual memory addressing techniques. According to the ARINC-653 specification, applications assigned to a partition access memory via a range of virtual memory addresses which are translated by a real-time operating system to a corresponding physical memory address for access via a kernel of the operating system.

Such memory-partitioned architectures can create difficulties for test interfaces, such as by obfuscating the physical memory address to which a variable name correlates. Moreover, to promote portability of applications executable by the avionics device (e.g., portability between devices, within memory, etc.,) assigned virtual memory ranges may be identical between physical memory partitions. Accordingly, a virtual memory address may correlate to multiple (e.g., each) physical memory partition, thereby further complicating memory access requests from the test application.

### SUMMARY

In one example, a device includes at least one processor, a transceiver configured to send and receive data, and at least one memory device. The at least one memory device includes a range of physical memory addresses divided into a plurality of physical memory partitions that each includes a sub-range of the range of physical memory addresses and corresponds to a range of virtual memory addresses. The at least one memory device is encoded with instructions that, when executed by the at least one processor, cause the at least one processor to receive, via the transceiver, a memory address request configured to request access to a requested physical memory address within the range of physical memory addresses. The at least one memory device is further encoded with instructions that, when executed by the at least one processor, cause the at least one processor to determine that the requested physical memory address is associated with one of the plurality of physical memory partitions, determine a virtual memory address corresponding to the requested physical memory address within the one of the plurality of physical memory partitions, and access the requested physical memory address via the determined virtual memory address.

In another example, a method of accessing, by a first device, physical memory of a second device having a range of physical memory addresses divided into a plurality of physical memory partitions that each comprises a sub-range of the range of physical memory addresses and corresponds to a range of virtual memory addresses includes translating a virtual memory address included in the range of virtual memory addresses corresponding to one of the plurality of physical memory partitions to a requested physical memory address that corresponds to a physical memory address of the sub-range of the range of physical memory addresses included in the one of the plurality of physical memory partitions. The method further includes transmitting, by the first device to the second device, a memory access request including an indication of the requested physical memory address, and translating, by the second device, the requested physical memory address to the virtual memory address. The method further includes accessing, by the second device, the requested physical memory address via the virtual memory address.

### BRIEF DESCRIPTION OF THE DRAWINGS

FIG. 1 is a block diagram of an example system that can access a physical memory address of a memory device having a plurality of physical memory partitions via a virtual memory address.

FIG. 2 is a flow diagram illustrating example operations of a system to access a physical memory address of a memory device having a plurality of physical memory partitions via a virtual memory address.

### DETAILED DESCRIPTION

According to techniques of this disclosure, a test interface can include a test device (e.g., a personal computer) and an embedded device (e.g., an avionics unit). Memory of the embedded device can be divided into a plurality of memory partitions. A range of virtual memory addresses can correspond to each of the partitions. In some examples, the range of virtual memory addresses can be the same for each of the partitions. As described herein, the test device can translate a virtual memory address (e.g., corresponding to a software variable name) to a corresponding physical memory address in one of the partitions, such as by using a symbol table that correlates variable names to physical memory addresses. The test device can transmit a memory access request (e.g., a memory read and/or write request) to the embedded device to access the physical memory address. The test device, responsive to receiving the memory access request, can determine which memory partition includes the physical memory address. The test device can translate the physical memory address to a corresponding virtual address for the determined partition, and can access the physical memory address via the virtual address. In this way, techniques of this disclosure can enable a test interface to access a physical memory address of a memory device having a plurality of physical memory partitions using an operating system that controls access to the physical memory via virtual addressing techniques.

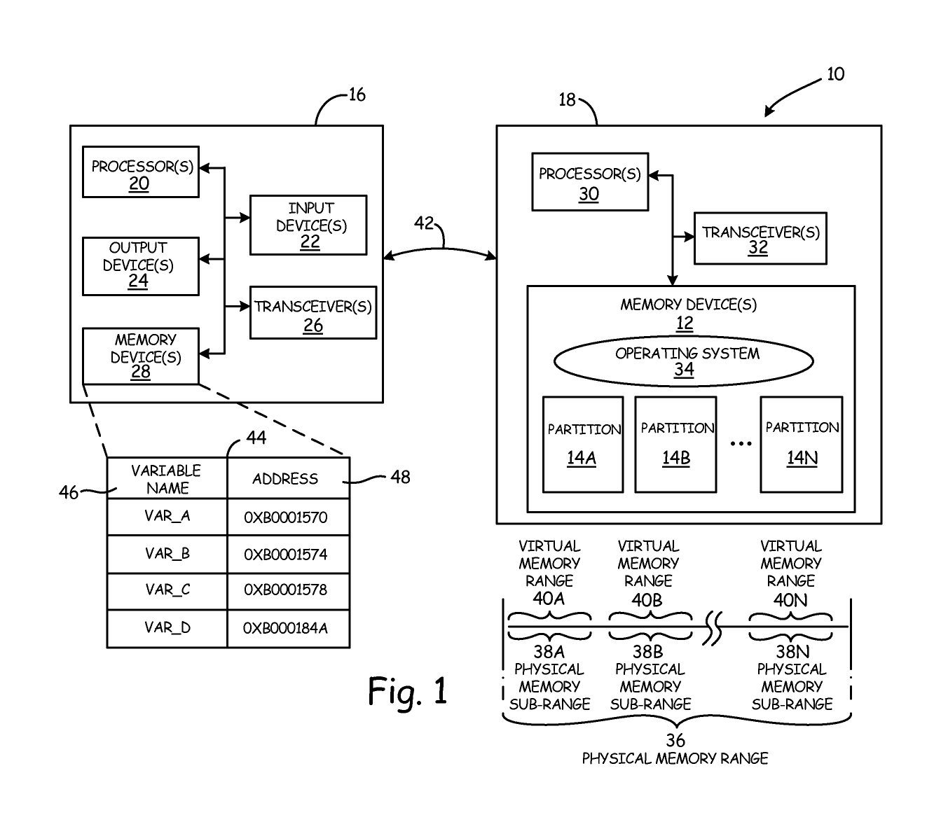

FIG. 1 is a block diagram of system 10 that can access a physical memory address of one or more memory devices 12 having a plurality of physical memory partitions 14A-14N via a virtual memory address. As illustrated in FIG. 1, system 10 can include testing device 16 and embedded device 18. Testing device 16 can include one or more processors 20, one or more input devices 22, one or more output devices 24, one or more transceivers 26, and one or more memory devices 28. Embedded device 18 can include one or more processors 30, one or more transceivers 32, and one or more memory devices 12.

Examples of testing device 16 can include, but are not limited to, a desktop computer, laptop computer, tablet computer, personal digital assistant (PDA), mobile phone (including smartphones), server, mainframe, or other computing device. In general, testing device 16 can be any computing device capable of executing a test application that interfaces with embedded device 18 by transmitting and receiving data to access (i.e., write to and/or read from) memory locations of one or more memory devices 12 of embedded device 18.

Processor 20, in one example, is configured to implement functionality and/or process instructions for execution within testing device 16. For instance, processor 20 can be capable of processing instructions stored in memory device 28. Examples of processor 20 can include any one or more of a microprocessor, a controller, a digital signal processor (DSP), an application specific integrated circuit (ASIC), a field-programmable gate array (FPGA), or other equivalent discrete or integrated logic circuitry.

As illustrated, testing device 16 can include one or more input devices 22. Input devices 22, in some examples, are configured to receive input from a user. Examples of input devices 22 can include a mouse, a keyboard, a microphone, a camera device, a presence-sensitive and/or touch-sensitive display, or other type of device configured to receive input from a user.

One or more output devices 24 can be configured to provide output to a user. Examples of output devices 24 can include a display device, a sound card, a video graphics card, a speaker, a cathode ray tube (CRT) monitor, a liquid crystal display (LCD), or other type of device for outputting information in a form understandable to users or machines.

Testing device 16, in some examples, also includes one or more transceivers 26. Testing device 16, in one example, utilizes transceiver 26 to communicate with external devices via one or more communication networks. Transceiver 26 can be any one or more of a network interface card, such as an Ethernet card, an optical transceiver, a radio frequency transceiver, or any other type of device that can send and receive information. Other examples of such transceivers can include Bluetooth, 3G, 4G, and WiFi radio transceivers as well as Universal Serial Bus (USB). In some examples, testing device 16 utilizes transceiver 26 to wirelessly communicate with an external device, such as embedded device 18.

One or more memory devices 28 can be configured to store information within testing device 16 during operation. Memory device 28, in some examples, can be described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory device 28 is not long-term storage. Memory device 28, in some examples, is described as a volatile memory, meaning that memory device 28 does not maintain stored contents when power to testing device 16 is turned off. Examples of volatile memories can include random access memories (RAM), dynamic random access memories (DRAM), static random access memories (SRAM), and other forms of volatile memories. In some examples, memory device 28 is used to store program instructions for execution by processors 20. Memory device 28, in one example, is used by software or applications running on testing device 16 (e.g., a test interface application) to temporarily store information during program execution.

Memory device 28, in some examples, also includes one or more computer-readable storage media. Memory device 28 can be configured to store larger amounts of information than volatile memory. Memory device 28 can further be configured for long-term storage of information. In some examples, memory device 28 includes non-volatile storage elements. Examples of such non-volatile storage elements can include magnetic hard discs, optical discs, floppy discs, flash memories, or forms of electrically programmable memories (EPROM) or electrically erasable and programmable memories (EEPROM).

As illustrated, embedded device 18 can include one or more processors 30, one or more transceivers 32, and one or more memory devices 12. In some examples, embedded device 18 can be an avionics device (e.g., a flight control computer, an air data computer, a flight management computer, etc.) that can be mounted in an aircraft or other aerial vehicle to sense and/or provide data for operation of the aircraft. In certain examples, embedded device 18 can determine one or more parameters of data that are considered flight-critical, such that loss or corruption of the one or more parameters is considered catastrophic to control of the aircraft.

Similar to processors 20 of testing device 16, processors 30 can be configured to implement functionality and/or process instructions (e.g., stored in memory devices 12) for execution within embedded device 18. Examples of processor 30 can include any one or more of a microprocessor, a controller, a digital signal processor (DSP), an application specific integrated circuit (ASIC), a field-programmable gate array (FPGA), or other equivalent discrete or integrated logic circuitry. Transceiver 32, in certain examples, can be substantially similar to transceiver 26 of testing device 16, in that transceiver 32 can be any wired or wireless device configured to send and receive information, such as to testing device 16 via a communication network. Memory device 12 can be substantially similar to memory device 28. That is, memory device 12 can be considered a computer-readable storage device that includes any volatile and/or non-volatile memory that can store data and/or program instructions for execution within embedded device 18.

As illustrated in FIG. 1, memory device 12 can include program instructions for executing operating system 34. Operating system 34 can, in some examples, control the operation of components of embedded device 18. In certain examples, operating system 34 can be a real-time operating system (RTOS) that schedules execution of applications executing on processors 30 and serves real-time application requests, such as requests for access to memory device 12 (e.g., read and/or write requests).

As further illustrated, memory device 12 can include physical memory partitions 14A-14N (collectively referred to herein as “memory partitions 14”). Memory partitions 14 can each include a range of physical memory addresses of memory device 12. Physical memory addresses can be memory addresses of actual hardware devices of embedded device 18, such as memory addresses of physical RAM, a universal asynchronous receiver/transmitter (UART), or other physical hardware of embedded device 18.

Memory partitions 14 can divide one or more ranges of physical memory into a plurality of sub-ranges of the physical memory. For example, as illustrated in FIG. 1, memory device 12 can include physical memory range 36. Physical memory range 36 can be a range of memory addresses in memory device 12 that extends from a first memory address to a last memory address. In certain examples, physical memory range 36 can be a contiguous range of addresses in physical memory, such that physical memory range 36 includes a plurality of sequential physical memory addresses extending from the first memory address to the last memory address of physical memory range 36. In other examples, physical memory range 36 can be a discontinuous range of memory addresses, in that physical memory addresses within physical memory range 36 may not be sequential, but may be located in different portions of memory or different memory devices.

Memory partitions 14 can each include a sub-range of physical memory addresses within physical memory range 36. For example, as illustrated in FIG. 1, each of physical memory sub-ranges 38A-38N (collectively referred to herein as “memory sub-ranges 38”) can correspond to a respective one of memory partitions 14A-14N, such that physical memory partition 14A includes physical memory sub-range 38A, physical memory partition 14B includes physical memory sub-range 38B, and physical memory partition 14N includes physical memory sub-range 38N.

As further illustrated, each of memory sub-ranges 38 corresponds to one of virtual memory ranges 40A-40N (collectively referred to herein as “virtual memory ranges 40”). That is, physical memory sub-range 38A corresponds to virtual memory range 40A, physical memory sub-range 38B corresponds to virtual memory range 40B, and physical memory sub-range 38N corresponds to virtual memory range 40N. Each of virtual memory ranges 40 can include a range of virtual memory addresses that can be used by applications executing on embedded device 18 and mapped to corresponding physical memory addresses by operating system 34 for access to locations of memory device 12, as is further described below. Physical memory within memory sub-range 38 can correspond in a one-to-one manner to virtual memory addresses within a corresponding one of virtual memory ranges 40. That is, each physical memory address within sub-ranges 38 can map to one virtual address in a corresponding one of virtual memory ranges 40, such that no physical memory address within sub-ranges 38 maps to more than one virtual memory address. In some examples, a sequential order of physical memory within sub-ranges 38 can be the same as a sequential order of corresponding virtual memory within virtual memory ranges 40. Accordingly, in such examples, a distance (e.g., a number of bits or bytes) between a physical memory address in one of memory sub-ranges 38 and a starting physical address of the sub-range can be the same as a distance between a virtual address in a corresponding one of virtual memory ranges 40 and a starting virtual address of the virtual memory range.

Memory device 12 can include any number of memory partitions 14, memory sub-ranges 38, and virtual memory ranges 38N, such as two, three, five, or more memory partitions, memory sub-ranges and virtual memory ranges. Accordingly, memory partitions 14, memory sub-ranges 38, and virtual memory ranges 40 are illustrated and described as including “N” memory partitions, memory sub-ranges, and virtual memory ranges, where “N” represents an arbitrary number.

In operation, a size and location of memory partitions 14 can be initialized, such as by a memory management unit (not illustrated) via operating system 34 during an initialization phase of embedded device 18 (e.g., on boot, load, power-up, and the like). In addition, applications executing on processor 30 can be assigned to one of memory partitions 14. Operating system 34 can limit memory access of the applications to memory within the one of sub-ranges 38 associated with the memory partition via virtual address ranges 40. That is, applications executing on processor 30 can be initialized to operate over a corresponding one of virtual address ranges 40. Each of virtual address ranges 40 can have a different starting and ending memory address than the corresponding one of memory sub-ranges 38. In operation, applications access memory via operating system 34 using virtual memory addresses within the virtual memory address range with which it was initialized. Operating system 34 translates the virtual memory address to a corresponding physical address within the corresponding one of memory sub-ranges 38 to access the physical memory address. In this way, operating system 34 controls access of applications to physical memory of a partition to which the application is assigned, thereby helping to prevent memory corruption between partitions. In some examples, operating system 34 and memory device 12 can be configured according to the ARINC-653 specification for space and time partitioning in safety-critical real-time operating systems.

As one example, an application executing on processors 30 can be assigned to operate within physical memory partition 14A. Accordingly, operating system 34 can initialize the application to operate within virtual memory range 40A that corresponds to physical memory sub-range 38A. The application can access memory via memory access requests (e.g., read and/or write requests) using virtual memory addresses within virtual memory range 40A. Upon receiving a memory access request (e.g., an interrupt) from the application including a virtual memory address, operating system 34 can translate the virtual memory address to a corresponding one of physical addresses within physical memory sub-range 38A. Because the application is configured to operate only within virtual memory address range 40A, which does not directly correlate to physical memory addresses within physical memory range 36, the application is effectively prevented from accessing (e.g., writing to) memory locations outside of physical memory sub-range 38A, thereby preventing the application from inadvertently corrupting memory at a memory location outside of its assigned memory partition.

In certain examples, each of virtual memory ranges 40 can be an identical range of virtual memory addresses. That is, each of virtual memory ranges 40 can range from a same starting virtual memory address to a same ending virtual memory address. By assigning each of virtual memory ranges 40 to a same range of virtual memory addresses, portability of applications assigned to a partition can be enhanced. That is, when each of virtual memory ranges 40 is a same range of virtual memory addresses, an application assigned to operate over one of virtual memory ranges 40 can effectively be ported to any partition or range of physical memory addresses without requiring changes to the application to compensate for the differing physical memory locations.

As illustrated in FIG. 1, testing device 16 can transmit memory access requests to and/or receive responses from embedded device 18 via communication pathway 42. Communication pathway 42 can, in some examples, be a communication network, such as a wired or wireless communication network. The communication network can include wired or wireless networks or both, such as local area networks (LANs), wireless local area networks (WLANs), cellular networks, wide area networks (WANs) such as the Internet, or other types of networks. In other examples, communication pathway 42 can be a point-to-point or peer-to-peer communication pathway, such as via Ethernet, Serial Bus, or other communication protocols.

Testing device 16 can transmit a memory access request to embedded device 18 to request access to one or more memory locations of memory device 12. For instance, testing device 16 can execute a testing application including, e.g., a user interface that enables a user to provide an indication of the memory address location, such as via a variable name representative of the memory location. Testing device 16 can include an indication of a physical memory address of the variable name, such as by using table 44 that translates variable names to corresponding physical memory address locations within memory devices 12. For instance, as illustrated in FIG. 1, table 44 can include column 46 that includes a variable name representative of a memory location and column 48 that includes a physical memory address of memory device 12 corresponding to the variable name. While illustrated and described in the example of FIG. 1 as a table, table 44 can be implemented in memory device 28 as any data structure capable of associating a variable name with a corresponding memory address, such as an array, a matrix, a hash table, a linked list, or other such data structure.

Table 44 can be constructed to translate a virtual memory address within one of virtual memory ranges 40 to a corresponding physical memory address within one of memory sub-ranges 38. For instance, because virtual memory ranges 40 can each correspond to a same range of virtual memory addresses, a memory access request from testing device 16 that includes one of the virtual memory addresses could be ambiguous to embedded device 18, in that embedded device 18 could be unable to uniquely identify the requested physical address associated with the variable name from the requested virtual memory address. Accordingly, table 44 can be constructed to uniquely translate variable names to a corresponding physical memory address.

In certain examples, individual symbol tables can be generated corresponding to each of memory partitions 14 that correlate variable names with virtual memory addresses within an associated one of virtual memory ranges 40. In some examples, memory device 28 can include instructions to convert the virtual memory addresses for each individual symbol table to corresponding physical memory addresses for the respective one of memory partitions 14 (e.g., upon boot-up or initialization) using the following equation:

A_{Physical}=A_{Partition}_{_{—}}_{Physical}_{_{—}}_{Start} (A_{Virtual}−A _{Virtual}_{_{—}}_{Start}) Equation (1)

In the above Equation 1, A_{Physical} represents the corresponding physical memory address within physical memory range 36, A _{Partition}_{_{—}}_{Physical}_{_{—}}_{Start} represents the starting physical memory address of the respective one of physical memory sub-ranges 38, A_{Virtual} represents the virtual memory address associated with the variable name within the respective one of virtual memory ranges 40, and A_{Virtual}_{_{—}}_{Start} represents the starting virtual memory address of the respective one of virtual memory ranges 40. In certain examples, memory device 28 can include instructions to concatenate the individual symbol tables including the determined physical memory addresses to construct table 44. In this way, testing device 16 can construct table 44 to translate variable names with corresponding physical memory addresses within physical memory range 36. In response to receiving input (e.g., from a user, a file, another computing device, or other source) to generate a memory access request, testing device 16 can utilize table 44 as a lookup table to identify a requested variable name and determine the corresponding physical memory address. In some examples, testing device 16 may not implement table 44 to translate the variable name to the corresponding physical memory address, but rather may utilize Equation 1 to dynamically determine the corresponding physical memory address.

Embedded device 18 can receive one or more memory access requests, including an indication of a requested physical memory address, from testing device 16 via communication pathway 42 and transceiver 32. Because applications associated with partitions 14 can be configured to execute over virtual memory ranges 40 rather than physical memory range 36 (e.g., according to the ARINC-653 specification), embedded device 18 can translate the requested physical memory address included in the memory access request to a corresponding one of virtual address ranges 40. For instance, embedded device 18 can identify which of memory partitions 14 includes the requested physical memory address, such as by iterating over memory sub-ranges 38 to determine which of memory sub-ranges 38 includes the requested physical memory address. Embedded device 18 can determine the virtual memory address within the identified one of memory partitions 14 that corresponds to the requested physical memory address using the following equation:

A_{Virtual}=A_{Virtual}_{_{—}}_{Starting}+(A_{Physical}−A_{Physical}_{_{—}}_{Partition}_{_{—}}_{Starting}) Equation (2)

In the above Equation 2, A_{Virtual} represents the virtual memory address corresponding to the requested physical memory address, A_{Virtual}_{_{—}}_{Starting} represents the starting virtual memory address of the one of virtual memory ranges 40 that corresponds to the identified one of memory partitions 14, A Physical represents the requested physical memory address, and A_{Physical}_{_{—}}_{Partition}_{_{—}}_{Starting} represents the starting physical memory address within the one of memory sub-ranges 38 corresponding to the identified one of memory partitions 14.

As an example, embedded device 18 can identify physical memory partition 14B as including the requested physical memory address, such as by determining that the requested physical memory address is greater than a starting physical memory address and less than a last physical memory address of physical memory sub-range 38B. Embedded device 18 can determine the virtual memory address within virtual memory range 40B corresponding to the requested physical memory address using Equation 2. Thereafter, embedded device can access the requested physical memory address via the determined virtual memory address. For instance, operating system 34 can translate the determined virtual memory address to a corresponding physical address within physical memory range 36, and can access the physical memory address via a kernel of operating system 34. In some examples, instructions to translate the physical memory address to the virtual memory address can be implemented as an application assigned to one of partitions 14. In other examples, the instructions to translate the physical memory address to the virtual memory address can be implemented as a task (e.g., a background task) of operating system 34.

Accordingly, as described herein, testing device 16 can translate a virtual memory address associated with, e.g., a variable name to a corresponding physical memory address within memory device 12 of embedded device 18. Testing device 16 can transmit a memory access request to embedded device 18 to request access to the physical memory address. Embedded device 18 can determine which of memory partitions 14 includes the requested physical memory address, and can translate the requested physical memory address to a virtual memory address of a corresponding one of virtual memory ranges 40. Operating system 34 can access the requested physical memory address via the translated virtual memory address. As such, techniques of this disclosure can enable a test interface to access a physical memory address of a device (e.g., an avionics device, such as a flight control computer) that implements a partitioned memory architecture using virtual memory addressing techniques, such as a partitioned memory architecture that complies with the ARINC-653 specification for space and time partitioning in safety-critical real-time operating systems.

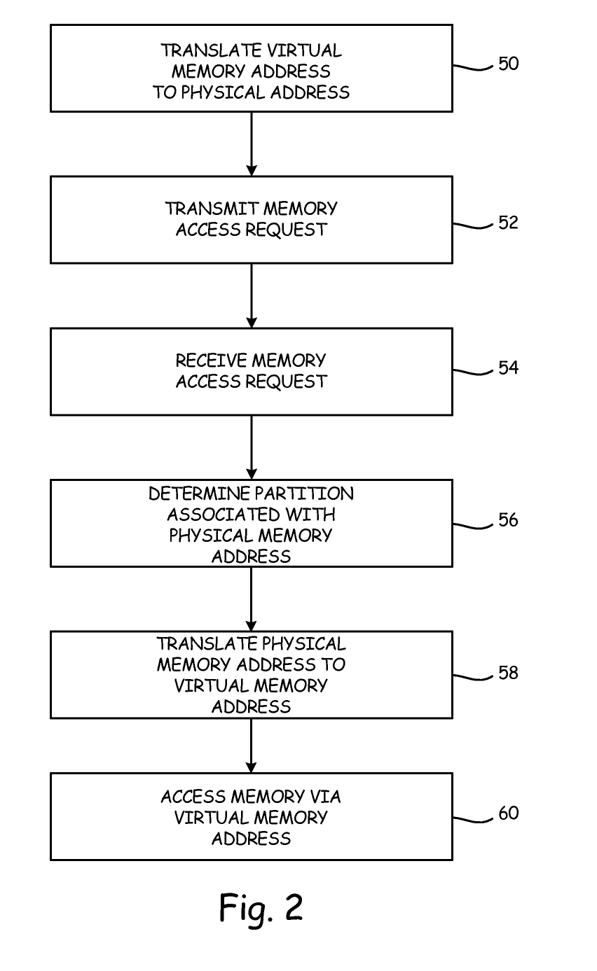

FIG. 2 is a flow diagram illustrating example operations of system 10 to access a physical memory address of memory device 12 having a plurality of physical memory partitions 14 via a virtual memory address. For purposes of illustration, the example operations are described below within the context of system 10 of FIG. 1.

A virtual memory address included in a range of virtual memory addresses corresponding to one of a plurality of physical memory partitions can be translated to a requested physical memory address that corresponds to a physical memory address of the sub-range of the range of physical memory addresses included in the one of the plurality of physical memory partitions (50). For instance, testing device 16 can utilize table 44 to translate a virtual address corresponding to one of variable names 46 identified via a test application executing on processor 20 to a corresponding one of physical memory addresses 48. In some examples, testing device 16 can determine the physical memory address via Equation 1, described above with respect to FIG. 1.

A first device can transmit a memory access request, including an indication of the requested physical memory address, to a second device having the range of physical memory addresses (52). For instance, testing device 16 can transmit a memory access request, such as a memory read and/or memory write request, to embedded device 18 via communication pathway 42. The second device can receive the memory access request (56), and can translate the requested physical memory address to the virtual memory address (58). For example, embedded device 18, responsive to receiving the memory access request from testing device 16, can determine which of partitions 14 includes the requested physical memory address, such as by determining which of physical memory sub-ranges 38 includes the requested physical memory address. Embedded device 18 can translate the requested physical address to a virtual memory address within a corresponding one of virtual memory ranges 40 via Equation 2 described above with respect to FIG. 1.

The requested physical memory address can be accesses via the virtual memory address (60). As an example, operating system 34 of embedded device 18 can access the requested physical address via the virtual address.

The following are non-exclusive descriptions of possible embodiments of the present invention.

A device includes at least one processor, a transceiver configured to send and receive data, and at least one memory device. The at least one memory device includes a range of physical memory addresses divided into a plurality of physical memory partitions that each includes a sub-range of the range of physical memory addresses and corresponds to a range of virtual memory addresses. The at least one memory device is encoded with instructions that, when executed by the at least one processor, cause the at least one processor to receive, via the transceiver, a memory address request configured to request access to a requested physical memory address within the range of physical memory addresses. The at least one memory device is further encoded with instructions that, when executed by the at least one processor, cause the at least one processor to determine that the requested physical memory address is associated with one of the plurality of physical memory partitions, determine a virtual memory address corresponding to the requested physical memory address within the one of the plurality of physical memory partitions, and access the requested physical memory address via the determined virtual memory address.

The device of the preceding paragraph can optionally include, additionally and/or alternatively, any one or more of the following features, configurations and/or additional components:

Each respective range of virtual memory addresses can include a same range of virtual memory addresses ranging from a same first virtual memory address to a same last virtual memory address.

The instructions to determine that the requested physical memory address is associated with the one of the plurality of physical memory partitions can further include instructions that, when executed by the at least one processor, cause the at least one processor to determine that the requested physical memory address is included within the sub-range of the range of physical memory addresses included in the one of the plurality of physical memory partitions.

The instructions to determine the virtual memory address corresponding to the requested physical memory address within the one of the plurality of physical memory partitions can further include instructions that, when executed by the at least one processor, cause the at least one processor to determine the virtual memory address corresponding to the requested physical memory address via a mapping function that uniquely correlates each respective memory address within the sub-range of the range of physical memory addresses included in the one of the plurality of physical memory partitions with a respective one of the range of virtual memory addresses corresponding to the one of the plurality of physical memory partitions.

The mapping function can include: A_{Virtual}=A_{Virtual}_{_{—}}_{Starting}=(A_{Physical}−A_{Physical}_{_{—}}_{Partition}_{_{—}}_{Starting}), where A_{Virtual} represents the virtual memory address corresponding to the requested physical memory address within the one of the plurality of memory partitions, A_{Virtual}_{_{—}}_{Starting} represents a first virtual memory address of the range of virtual memory addresses corresponding to one of the plurality of physical memory partitions, A_{Physical} represents the requested physical memory address, and A_{Physical}_{_{—}}_{Partition}_{_{—}}_{Starting} represents a first memory address within the sub-range of the range of physical memory addresses included in the one of the plurality of physical memory partitions.

The instructions to access the requested physical memory address via the determined virtual memory address can further include instructions that, when executed, cause the at least one processor to access the requested physical memory address via an application assigned to the one of the plurality of physical memory partitions.

The instructions to receive the memory access request, determine that the requested physical memory address is associated with the one of the plurality of physical memory partitions, and determine the virtual memory address can be implemented via an operating system, executable by the at least one processor, that controls access to the range of physical memory addresses.

The operating system can be a real-time operating system.

The range of physical memory addresses can be a contiguous range of physical memory addresses.

Each memory address of the range of physical memory addresses is included in only one of the plurality of physical memory partitions.

A method of accessing, by a first device, physical memory of a second device having a range of physical memory addresses divided into a plurality of physical memory partitions that each comprises a sub-range of the range of physical memory addresses and corresponds to a range of virtual memory addresses can include translating a virtual memory address included in the range of virtual memory addresses corresponding to one of the plurality of physical memory partitions to a requested physical memory address that corresponds to a physical memory address of the sub-range of the range of physical memory addresses included in the one of the plurality of physical memory partitions. The method can further include transmitting, by the first device to the second device, a memory access request including an indication of the requested physical memory address, and translating, by the second device, the requested physical memory address to the virtual memory address. The method can further include accessing, by the second device, the requested physical memory address via the virtual memory address.

The method of the preceding paragraph can optionally include, additionally and/or alternatively, any one or more of the following features, configurations, additional components and/or operations:

Translating the virtual memory address to the requested physical memory address can include constructing a symbol table that correlates variable names associated with virtual memory addresses included in the range of virtual memory addresses using a mapping function, and translating the virtual memory address to the requested physical memory address via the symbol table.

The mapping function can include: A_{Physical}=A_{Partition}_{_{—}}_{Physical}_{_{—}}_{Start}+(A_{Virtual}−A_{Virtual}_{_{—}}_{Start}), where A_{Physical} represents the requested physical memory address, A_{Partition}_{_{—}}_{Physical}_{_{—}}_{Start} represents a starting physical memory address of the sub-range of the range of physical memory addresses included in the one of the plurality of physical memory partitions, A_{Virtual} represents the virtual memory address, and A_{Virtual}_{_{—}}_{Start} represents a starting virtual memory address of the range of virtual memory addresses corresponding to the one of the plurality of physical memory partitions.

Translating, by the second device, the requested physical memory address to the virtual memory address can include translating via a mapping function that uniquely correlates each respective memory address within the sub-range of the range of physical memory addresses included in the one of the plurality of physical memory partitions with a respective one of the range of virtual memory addresses corresponding to the one of the plurality of physical memory partitions.

The mapping function can include: A_{Virtual}=A_{Virtual}_{_{—hd Starting}}+(A_{Physical}−A_{Physical}_{_{—}}_{Partition}_{_{—}}_{Starting}), where A_{Virtual} represents the virtual memory address corresponding to the requested physical memory address within the one of the plurality of memory partitions, A_{Virtual}_{_{—}}_{Starting} represents a first virtual memory address of the range of virtual memory addresses corresponding to one of the plurality of physical memory partitions, A_{Physical} represents the requested physical memory address, and A_{Physical}_{_{—}}_{Partition}_{_{—}}_{Starting} represents a first memory address within the sub-range of the range of physical memory addresses included in the one of the plurality of physical memory partitions.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device comprising:
at least one processor;
a transceiver configured to send and receive data; and
at least one memory device comprising a range of physical memory addresses divided into a plurality of physical memory partitions that each comprises a sub-range of the range of physical memory addresses and corresponds to a range of virtual memory addresses, the at least one memory device encoded with instructions that, when executed by the at least one processor, cause the at least one processor to:
receive, via the transceiver, a memory access request configured to request access to a requested physical memory address within the range of physical memory addresses;
determine that the requested physical memory address is associated with one of the plurality of physical memory partitions;
determine a virtual memory address corresponding to the requested physical memory address within the one of the plurality of physical memory partitions; and
access the requested physical memory address via the determined virtual memory address.

2. The device of claim 1, wherein each respective range of virtual memory addresses comprises a same range of virtual memory addresses ranging from a same first virtual memory address to a same last virtual memory address.

3. The device of claim 1, wherein the instructions to determine that the requested physical memory address is associated with the one of the plurality of physical memory partitions further comprise instructions that, when executed by the at least one processor, cause the at least one processor to determine that the requested physical memory address is included within the sub-range of the range of physical memory addresses included in the one of the plurality of physical memory partitions.

4. The device of claim 1, wherein the instructions to determine the virtual memory address corresponding to the requested physical memory address within the one of the plurality of physical memory partitions further comprise instructions that, when executed by the at least one processor, cause the at least one processor to determine the virtual memory address corresponding to the requested physical memory address via a mapping function that uniquely correlates each respective memory address within the sub-range of the range of physical memory addresses included in the one of the plurality of physical memory partitions with a respective one of the range of virtual memory addresses corresponding to the one of the plurality of physical memory partitions.

5. The device of claim 4, wherein the mapping function comprises:
A_{Virtual}=A_{Virtual}_{_{—}}_{Starting}+(A_{Physical}−A_{Physical}_{_{—}}_{Partition Starting});
wherein A_{Virtual} represents the virtual memory address corresponding to the requested physical memory address within the one of the plurality of memory partitions;
wherein A_{Virtual}_{_{—}}_{Starting} represents a first virtual memory address of the range of virtual memory addresses corresponding to one of the plurality of physical memory partitions;
wherein A_{Physical} represents the requested physical memory address; and
wherein A_{Physical}_{_{—}}_{Partition}_{_{—}}_{Starting} represents a first memory address within the sub-range of the range of physical memory addresses included in the one of the plurality of physical memory partitions.

6. The device of claim 1, wherein the instructions to access the requested physical memory address via the determined virtual memory address further comprise instructions that, when executed, cause the at least one processor to access the requested physical memory address via an application assigned to the one of the plurality of physical memory partitions.

7. The device of claim 1, wherein the instructions to receive the memory access request, determine that the requested physical memory address is associated with the one of the plurality of physical memory partitions, and determine the virtual memory address are implemented via an operating system, executable by the at least one processor, that controls access to the range of physical memory addresses.

8. The device of claim 7, wherein the operating system comprises a real-time operating system.

9. The device of claim 1, wherein the range of physical memory addresses comprises a contiguous range of physical memory addresses.

10. The device of claim 1, wherein each memory address of the range of physical memory addresses is included in only one of the plurality of physical memory partitions.

11. A method of accessing, by a first device, physical memory of a second device having a range of physical memory addresses divided into a plurality of physical memory partitions that each comprises a sub-range of the range of physical memory addresses and corresponds to a range of virtual memory addresses, the method comprising:
translating a virtual memory address included in the range of virtual memory addresses corresponding to one of the plurality of physical memory partitions to a requested physical memory address that corresponds to a physical memory address of the sub-range of the range of physical memory addresses included in the one of the plurality of physical memory partitions;
transmitting, by the first device to the second device, a memory access request including an indication of the requested physical memory address;
translating, by the second device, the requested physical memory address to the virtual memory address; and
accessing, by the second device, the requested physical memory address via the virtual memory address.

12. The method of claim 11, wherein translating the virtual memory address to the requested physical memory address comprises:
constructing a symbol table that correlates variable names associated with virtual memory addresses included in the range of virtual memory addresses using a mapping function; and
translating the virtual memory address to the requested physical memory address via the symbol table.

13. The method of claim 12, wherein the mapping function comprises:
A_{Physical}=A_{Partition}_{_{—}}_{Physical}_{_{—}}_{Start}+(A_{Virtual}−A_{Virtual Start});
wherein A_{Physical} represents the requested physical memory address;
wherein A_{Partition}_{_{—}}_{Physical}_{_{—}}_{Start} represents a starting physical memory address of the sub-range of the range of physical memory addresses included in the one of the plurality of physical memory partitions;
wherein A_{Virtual} represents the virtual memory address; and
wherein A_{Virtual}_{_{—}}ₛₜₐᵣₜ represents a starting virtual memory address of the range of virtual memory addresses corresponding to the one of the plurality of physical memory partitions.

14. The method of claim 11, wherein translating, by the second device, the requested physical memory address to the virtual memory address comprises translating via a mapping function that uniquely correlates each respective memory address within the sub-range of the range of physical memory addresses included in the one of the plurality of physical memory partitions with a respective one of the range of virtual memory addresses corresponding to the one of the plurality of physical memory partitions.

15. The method of claim 14, wherein the mapping function comprises:
A_{Virtual}=A_{Virtual}_{_{—}}_{Starting}+(A_{Physical}−A_{Physical}_{_{—}}_{Partition Starting});
wherein A_{Virtual} represents the virtual memory address corresponding to the requested physical memory address within the one of the plurality of memory partitions;
wherein A_{Virtual}_{_{—}}_{Starting} represents a first virtual memory address of the range of virtual memory addresses corresponding to one of the plurality of physical memory partitions;
wherein A_{Physical} represents the requested physical memory address; and
wherein A_{Physical}_{_{—}}_{Partition}_{_{—}}_{Starting} represents a first memory address within the sub-range of the range of physical memory addresses included in the one of the plurality of physical memory partitions.
